(19) United States
(12) Patent Application Publication
(10) Pub. No.: US 2008/0162452 A1
(43) Pub. Date: Jul. 3, 2008

(54) PERFORMANCE ASSESSMENT OF POLICIES IN POLICY BASED NETWORKS

(75) Inventors: Gregory W. Cox, Schaumburg, IL (US); Walter L. Johnson, Hoffman Estates, IL (US); John C. Strassner, North Barrington, IL (US)

Correspondence Address: FLEIT, KAIN, GIBBONS, GUTMAN, BONGINI;& BIANCO P.L., 551 N.W. 77TH STREET, SUITE 111, BOCA RATON, FL, 33487, US

(73) Assignee: Motorola, Inc., Schaumburg, IL (US)

(21) Appl. No.: 11/618,314

(22) Filed: Dec. 29, 2006

(51) Int. Cl. G06F 17/30

(52) U.S. Cl. 707/5

(57) ABSTRACT

A method and system for evaluating performance of a policy rule (101) includes a memory (406) and processor (404) adapted for accessing at least one policy rule (101) having associated with it at least one policy event (102), at least one policy action (104), and at least one policy condition (103). Next, the policy rule (101) is associated with at least one policy evaluation event (105), at least one policy evaluation condition (106), and at least one policy evaluation action (107), wherein the policy evaluation event (105) is independent of the policy event (102) which triggers the policy rule (101). Performance of the policy rule (101) is then assessed by utilizing the policy evaluation condition (106) and the policy evaluation action (107).

### FIELD OF THE INVENTION

This invention relates in general to policy-based network management, and more specifically to the evaluation of policy rules, and also their constituent policy events, policy conditions, and policy actions, after deployment in a policy-based network management system.

### BACKGROUND OF THE INVENTION

Policy is a set of rules that are used to manage and control the changing and/or maintaining of the state of one or more managed object or entities. Policy rules comprise events, conditions and actions. Policy events trigger the evaluation of policy conditions that may lead to the execution of policy actions.

Policy-based network management (PBNM) controls the state of the system and objects within the system using policies. Control is implemented using a management model, such as a finite state machine. It includes installing and deleting policy rules as well as monitoring system performance to ensure that the installed policies are working correctly. PBNM is concerned with the overall behavior of the system and adjusts the policies that are in effect based on how well the system is achieving its goals as expressed in the policy rules.

In a policy-based network of significant size, such as a converged-services wireless network offering seamless mobility, there will be a very large number of policies at different levels of the policy continuum to support and govern the complex operations of the system. It is also expected that errors, policy conflicts, and sub-optimal policies will come into such complex systems or that system context will change rendering formerly effective policies ineffective. The prior-art does not offer a solution to determining which policies are performing well and which policies are not performing well and therefore may need modification.

Therefore, a need exists to overcome the problems with the prior art as discussed above.

### SUMMARY OF THE INVENTION

A method and system are disclosed for evaluating performance of a policy rule. The method includes accessing at least one policy rule having associated with it at least one policy event, at least one policy condition, and at least one policy action, and associating with the policy rule at least one policy evaluation event, at least one policy evaluation condition, and at least one policy evaluation action, wherein the policy evaluation event may be partially or fully independent of the at least one policy event that triggers evaluation of the policy conditions in a policy rule. Performance of the policy rule is then assessed by utilizing the policy evaluation event(s), the policy evaluation condition(s) and the policy evaluation action(s).

In accordance with an added feature of the invention, the policy evaluation action can execute independently of the policy action for a given policy rule. This allows for policy rules that take no action to be evaluated. This is advantageous since failure to act may itself be important to evaluating the performance of a policy rule.

In accordance with an additional feature of the invention, the associating includes a policy evaluation condition that is independent of the policy condition.

In accordance with yet another feature of the invention, the method includes performing the policy evaluation action associated with the policy rule and at least one additional policy evaluation action on at least one additional policy rule, and then ranking the policy rule against the additional policy rule based on the result of the policy evaluation actions. Each policy evaluation action typically operates, at least in part, to manipulate a performance metric or metrics associated with the policy rules. Performance metrics may be, for example, real-valued policy performance scores wherein a higher score reflects better performance.

In accordance with yet a further feature of the invention, a system for evaluating performance of a policy rule is disclosed, where the system includes a memory adapted to store at least one policy rule, at least one policy event, at least one policy action, and at least one policy condition. The system also includes a processor communicatively coupled to the memory and adapted to access the at least one policy rule and associate at least one policy event, at least one policy condition, and at least one policy action with the policy rule. The processor is also adapted to associate at least one policy evaluation event, at least one policy evaluation condition, and at least one policy evaluation action with the policy rule, wherein the policy evaluation event is partially or fully independent of the policy event that triggers the policy rule. Finally, the processor is adapted to assess a performance of the policy rule by utilizing the at least one policy evaluation event, the at least one policy evaluation condition, and the at least one policy evaluation action.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is block diagram illustrating an augmented policy rule structure, according to an embodiment of the present invention;

FIG. 2 is a block diagram illustrating a policy-based system, according to an embodiment of the present invention;

FIG. 3 is a process flow diagram of an evaluation of policy performance, according to an embodiment of the present invention; and

FIG. 4 is a high level block diagram of the policy server of FIG. 2, according to an embodiment of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The present invention provides automatic effectiveness rating of policies according to performance evaluation events, conditions, and actions leading to the generation of policy performance metrics. As a result, poor performing policies (as determined, for example, by their low relative performance rank or by comparison of their performance metric(s) to threshold(s) showing them to be below the threshold(s)) can be addressed by, for instance, a reduction in their priority (e.g., they are less likely to win a policy conflict resolution) or by calling attention to them for editing and refinement by policy authors (e.g., calling for manual intervention). High performing policies (as determined, for example, by their high relative performance rank or by comparison of their performance metric(s) the threshold(s) showing them to be above the threshold(s)) can also be called out for special attention (e.g., by giving positive feedback to policy authors to encourage authorship of better policies).

A policy is typically defined as a set of rules. Each policy rule includes an event clause, a condition clause and an action clause. Upon triggering event(s), if the condition clause evaluates to TRUE, then the actions in the action clause are allowed to execute. If the condition clause evaluates to FALSE, the policy rule may also specify “otherwise” policy actions in the action clause to be executed. Therefore, one definition of policy management is: the usage of policy rules to accomplish decisions.

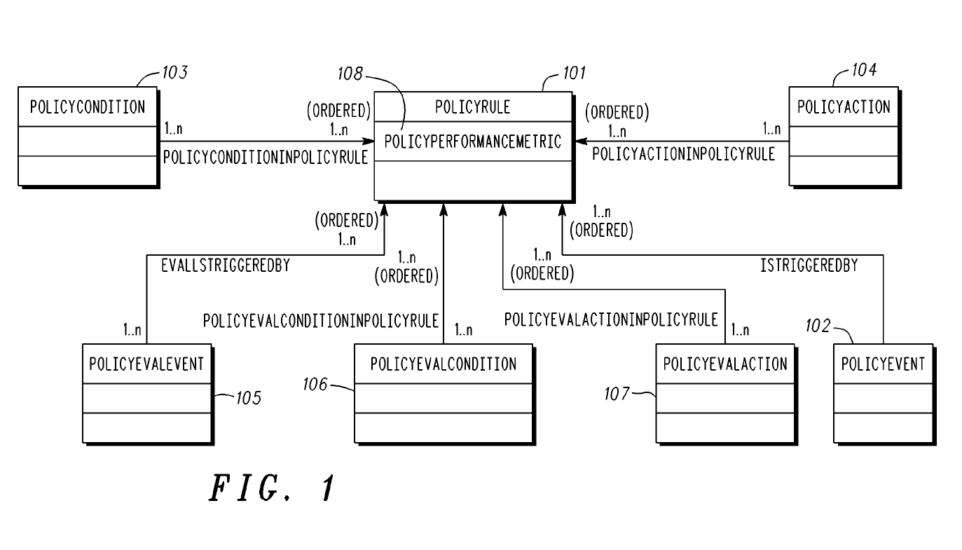

Policy is usually represented as a set of classes and relationships that define the semantics of the building blocks of representing policy. The fundamental unit of policy is a policy rule. FIG. 1 illustrates a model of a policy rule 101 in accordance with an embodiment of the present invention. The policy rule 101 includes one or more policy events 102, policy conditions 103, and policy actions 104. This Event/Condition Action 3-tuple is a common definition of a policy rule in the art. FIG. 1 incorporates the simplified Directory Enabled Networks-new generation (DEN-ng) policy model as described in Policy-Based Network Management, John C. Strassner, Morgan Kaufmann Publishers, 2004—the contents of which are hereby incorporated by reference. An embodiment of the present invention adds one or more policy evaluation events 105, policy evaluation conditions 106, and policy evaluation actions 107 to the policy rule 101. The policy evaluation events 105, policy evaluation conditions 106, and policy evaluation actions 107 parallel the function of the policy's existing events, conditions, and actions, but are used exclusively for the purpose of evaluating the policy rule's 101 performance.

The special case event “ALWAYS” is allowed in policy events 102 and policy evaluation events 105. This allows policy rules 101 to continually test policy conditions 103 and/or policy evaluation conditions 106 and conditionally execute policy actions 104 and/or policy evaluation actions 107 rather than waiting for one or more trigger events.

The special case conditions “TRUE” and “FALSE” are allowed in policy conditions 103 and policy evaluation conditions 106. This allows for unconditional policy actions 104 and/or policy evaluation actions 107 to occur based solely on triggering by associated policy events 102 and/or policy evaluation events 107.

A given policy rule's 101 specified policy evaluation events 105 and policy evaluation conditions 103 trigger evaluation of the performance and effectiveness of that policy rule 101. The policy evaluation events 105, policy evaluation conditions 106, and policy evaluation actions 107 can either be specified by the policy rule's 101 author or editor, or another author or editor whose expertise is performance evaluation. The policy evaluation actions 107 update a policy performance metric 108 (e.g., a real value, defaulting to zero) associated with the policy rule 101 and shown as an attribute of the policy rule 101 in FIG. 1. The policy performance metric 108 is written so as to allow comparison of policy rules on the same scale within a given system.

An embodiment of the present invention maintains an effectiveness ranking and metric rating for all policy rules 101. The effectiveness ranking can be useful, for example, to call ineffective policies to the attention of the system operator or to flag poor-performing policies. Alternatively, or in combination, ineffective policies can be de-prioritized relative to more effective policies in the event of a policy conflict, according to other possible embodiments. The invention is not limited to any particular response to identification of poor-performing or high-performing policies.

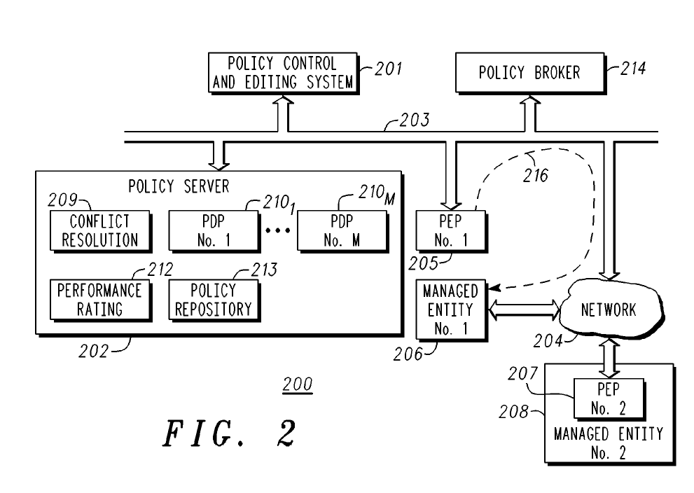

FIG. 2 illustrates a simple policy-based system 200 according to an embodiment of the present invention. Note that the simple nature of the example system shown in FIG. 2 does not constrain the present invention, which is capable of enhancing the operation of policy-based systems of large size and great complexity.

In FIG. 2, a policy control and editing system 201 receives, edits, and maintains the policy rules 101 (not shown). A policy server 202 actively manages the policy rules 101 governing operation of the system. A policy system bus 203 connects the policy system components and connects the policy system to the managed network 204. A Policy Execution Point (PEP) #1 205 implements policy actions 104 (not shown) directed toward a managed entity #1 206. In this example case, PEP #1 205 and the managed entity #1 206 are separate and communicate via the policy system bus 203 and the network 204 as shown by the broken line 216.

Another PEP, PEP #2 207, implements policy actions 104 (not shown) directed toward a managed entity #2 208. In this case, PEP #2 207 is co-located with its corresponding managed entity #2 208.

The policy server 202 includes several components. A conflict resolution component 209 works to resolve conflicts between policy rules 101. A policy conflict occurs when the conditions of two or more policy rules that apply to the same set of managed objects are simultaneously satisfied, but the actions of two or more of these policy rules conflict with each other. An example of this is shown below in Code Section #5. One or more Policy Decision Points (PDPs) 210₁-210ₘ evaluate policy conditions 103 and policy evaluation conditions 106. In accordance with one embodiment of the present invention, a performance metric, or rating component 212, maintains the ordered list of policy rules 101 and their performance ratings. In other embodiments, the performance rating component 212 may apply specified thresholds to policy rule 101 performance, selectively calling operator attention to policy rules 101 according to their performance. In other embodiments, the performance rating component 212 may respond to requests for input from the conflict resolution component 209 to help resolve policy rule 101 conflicts. A policy repository component 213 is provided within the policy server 202 to store the policy rules 101. PEPs 205, 207 also handle policy events 102 and policy evaluation events 105 as well as requested evaluation of policy conditions 103 and policy evaluation conditions 106 by PDPs 210₁-210ₘ.

The division of policy-based management tasks illustrated in FIG. 2 and as described herein is one example of how tasks may be divided in a policy-based network. Other entities may participate in or execute these functions. This re-partitioning of functionality does not depart from the spirit and scope of the present invention.

The policy-based system 200, in accordance with one embodiment of the present invention, also includes a policy broker 214. The policy broker 214 controls how different policy servers 202 interact with each other and ensures that conflicts do not exist between the policy servers 202. The policy broker 214 also coordinates the application of different policy rules 101 in different policy servers 202.

In addition, in some embodiments of the present invention, the policy broker 214 reconciles and coordinates the policy performance ratings between multiple policy servers 202, ensuring, for example, that the ratings are compared on the same numerical scale. For example, one policy server 202 may have performance ratings ranging from −100 (worst) to +100 (best) and another policy server 202 might have performance ratings from 0 (worst) to 400 (best). The policy broker 214 serving both of these policy servers 202, according to an embodiment of the present invention, might respond by dividing the performance ratings from the second policy server 202 by two and subtracting 100 before comparing it to the policy performance ratings from the first policy server 202.

The following section of code is an example of a policy rule, in accordance with one embodiment of the present invention. The example is known as pseudocode, which is code that is made up to illustrate the function of the code and does not necessarily conform to the rigors of a particular “real” language. For instance, there is no compiler for this code. In policy, this is especially useful given the shortage of real languages and the difficult in reading and limited expressiveness of existing policy languages in the art.

Pseudocode #1:

| | |
|---|---|
| 101 POLICY_RULE PR1a | // Defining PR1a |
| 102 ON_EVENT intf0.threshold_alarm | // PolicyEvent |
| 103 IF intf0.ifPktsDropped > SLA1.max_threshold1 | // PolicyCondition |
| THEN | |
| 104 ChangeQueuingPolicy(intf0, | // PolicyAction |
| violateQueuingPolicy); | |
| 105 ENDIF | |
| 106 END_EVENT | |
| 107 END_RULE | |

Pseudocode #1 shows an exemplary Event/Condition/Action (ECA) policy rule consistent with the known art. True policy languages in the art and those yet to come can be used in conjunction with the present invention.

In one embodiment, policy rule 101 handles an alarm by manipulating the queuing policy of an interface when too many packets have been dropped on that interface. The example policy rule's name “PR1a” is defined on line 101. Line 102 establishes an event to trigger the evaluation of the condition clause of policy rule PR1a. In this case, the policy event clause 102 contains just one event, which is an alarm on interface 0 (intf0.threshold_alarm). On line 103, the policy condition 103 tests how many packets have been dropped on interface 0. Again, in this case, the policy condition clause 103 contains just one condition. If more packets have dropped (intf0.ifPktsDropped) than a threshold value (SLA1.max_threshold1), the policy condition 103 will evaluate to TRUE. This will then cause the policy action clause (in this case, it contains a single policy action) to be executed. This runs the action (ChangeQueuingPolicy(intf0, violateQueuingPolicy)), which changes the queuing policy applied to interface 0 to a pre-defined policy (called violateQueuingPolicy) that will hopefully result in fewer dropped packets and prevent future alarm events.

It should be noted that the example code above is merely one example of policy code and is shown for clarity of explanation. Many variations including increases in complexity are within the spirit and scope of the present invention. For example, multiple policy events 102 can be used. More complex policy conditions 103 or combinations of conditions can also be used. Furthermore, multiple policy actions 104 or combinations of actions can be used. In addition, policy actions triggering on failure of the policy condition 103 can be used (e.g., this takes the form IF <condition clause is TRUE> THEN <execute TRUE actions> ELSE <execute FALSE actions> in the pseudocode form). Those of average skill in the art will readily realize that the teachings of the present invention would apply to these variations as well.

In accordance with an embodiment of the present invention, the following code, Code Section #2, exemplifies a policy rule, PR1a, with augmentation for performance measurement.

Code Section #2:

| 201 POLICY_RULE PR1a | // Defining PR1a |
|---|---|
| 202 ON_EVENT intf0.threshold_alarm | // PolicyEvent |
| 203 IF intf0.ifPktsDropped > | // PolicyCondition |
| SLA1.max_threshold1 THEN | |
| 204 ChangeQueuingPolicy(intf0, | // PolicyAction |
| violateQueuingPolicy); | |
| 205 Set(intf0.ifPktsForwarded, 0); | // PolicyAction |
| 206 ThrowEventDelayed(PR1a_Evaluate, 10.0); | // PolicyAction |
| 207 ENDIF | |
| 208 END_EVENT | |
| 209 | |

| | |
|---|---|
| 210 ON_EVENT PR1a_Evaluate | // PolicyEvalEvent |
| 211 IF intf0.ifPktsForwarded > 1000000 THEN | // PolicyEvalCondition |
| 212 PR1a.PolicyPerformanceMetric = 200.0 * | // PolicyEvalAction |
| 213 ((SLA1.max_threhold1 − | |
| intf0.ifPktsDropped) | |
| 214 / SLA1.max_threshold1) * 100.0; | |
| 215 ELSE | |
| 216 ThrowEventDelayed(PR1a_Evaluate, 10.0); | // PolicyEvalAction |
| 217 ENDIF | |
| 218 END_EVENT | |
| 219 END_RULE | |

Pseudocode #2 shows pseudocode for the example policy rule 101 PR1a of Code #1 augmented with a policy performance measurement according to an embodiment of the present invention. Lines 205, 206, and 209 through 218 were added to Pseudocode #1 for policy performance measurement. It should be noted here that the terms “policy performance measurement,” “policy performance evaluation,” and “policy evaluation” are equivalent and are used interchangeably herein. The aim of the performance measurement is to assess the effectiveness of PR1a at minimizing dropped packets on interface 0 given some time (in this example, 10 seconds) and sufficient statistics (in this example, at least 1,000,000 forwarded packets).

Line 205 adds a new policy action 104 of the policy rule PR1a to reset a packets forwarded counter. Line 206 adds another policy action 104 that sets a delayed event called “PR1a Evaluate” to trigger performance evaluation of PR1a as described below. The delay selected in this example is 10 seconds.

Line 210 is a policy evaluation event 107 with one member event, the delayed event named “PR1a_Evaluate,” possibly thrown by one of PR1a's policy actions 104 on line 206. Line 211 is a policy evaluation condition 108 for PR1a's evaluation. This condition tests to make sure a statistically significant number of packets have been forwarded by interface 0 to justify updating PR1a's performance evaluation. If so, then the policy evaluation action 109 on lines 212-214 updates PR1a's policy performance metric attribute, PR1a.PolicyPerformanceMetric. If not, then the policy evaluation action 109, defined on line 216, throws another delayed event for 10 seconds later to attempt an update of PR1a's policy performance metric. Note that in this example, policy evaluation actions 109 are defined for both passing and failing of PR1a's policy evaluation condition 108. The policy actions taken when the policy conditions evaluate to FALSE are termed “otherwise” actions.

PR1a, as shown in Pseudocode Section #2, is an example of a policy rule 101 whose policy action 104 must take place before the policy evaluation can take place. The following section of pseudocode is another exemplary policy rule for intrusion detection.

Pseudocode Section #3:

| | |
|---|---|
| 301 POLICY_RULE PR2a | // Defining PR2a |
| 302 ON_EVENT intf0.intrusion_attempt_detected | // PolicyEvent |
| | // PolicyCondition |

303 IF intf0.intrusion_attempt_severity >= SIGNIFICANT THEN

| | |
|---|---|
| 304 intf0.intrusion_attempt_detect_threshold−−; | // PolicyAction |
| 305 ELSE | // PolicyCondition |
| 306 intf0.intrusion_attempt_detect_threshold++; | // PolicyAction |
| 307 ENDIF | |
| 308 END_EVENT | |
| 309 END_RULE | |

Pseudocode Section #3 shows another example of a policy rule, PR2a. This example is intended to adjust the sensitivity of an intrusion detection threshold on interface 0 based on the severity of the intrusion attempt detected. The example policy rule PR2a implicitly assumes that detection of more significant intrusion attempts (attempts that can do more damage) justify increasing the intrusion detection sensitivity by lowering the intrusion attempt detection threshold. If the intrusion attempt is less significant (attempts that would do less damage), the example embodiment of the present invention decreases the intrusion detection sensitivity in order to increase the intrusion detection threshold. This example is deliberately simple for the purpose of clarity of illustration so as to show a particular advantage of the present invention, which will be illustrated in pseudocode #4. In particular, the example of pseudocode #4 is designed to illustrate the benefits of policy performance evaluation occurring without requiring that one or more of a policy rule's 101 policy actions 104 have occurred.

Line 301 names this policy rule “PR2a”. Line 302 defines the policy event 102 (ON_EVENT intf0.intrusion_attempt detected) for PR2a as an intrusion detection event on interface 0. Line 303 defines a policy condition 103 (IF intf0.intrusion_attempt_severity>=SIGNIFICANT) that tests the severity of the intrusion attempt that triggered the policy rule PR2a. Line 304 defines a policy action 104 (Intf0.intrusion_attempt_detect_threshold−−) to be executed when the policy condition 103 on line 303 evaluates to TRUE. The policy action 104 on line 304 is to decrease the intrusion attempt detection threshold, causing more intrusion attempts to be detected on interface 0. Line 306 defines a policy action 104 (Intf0.intrusion_attempt_detect_threshold++;) to be executed when the policy condition 103 on line 303 evaluates to FALSE. The policy action on line 306 increases the intrusion detection threshold on interface 0, causing fewer intrusion detection attempts to be detected on interface 0.

The following section of code, Pseudocode Section #4, is a second example, in accordance with an embodiment of the present invention, of a policy rule for intrusion detection with policy performance measurement.

Pseudocode Section # 4:

| | |
|---|---|
| 401 POLICY_RULE PR2a | // Defining PR2a |
| 402 ON_EVENT intf0.- | // PolicyEvent |
| intrusion_attempt_detected | // PolicyCondition |

403 IF intf0.intrusion_attempt_severity >= SIGNIFICANT THEN

| | |
|---|---|
| 404 Intf0.intrusion_attempt_detect_threshold−−; | // PolicyAction |
| 405 ELSE | // PolicyCondition |
| 406 Intf0.intrusion_attempt_detect_threshold++; | // PolicyAction |
| 407 ENDIF | |
| 408 END_EVENT | |
| 409 | |
| 410 ON_EVENT System_10sec_tic | // PolicyEvalEvent |
| 411 IF intf0.intrusion_succeeded_count > 0 | // PolicyEvalCondition |
| THEN | |
| 412 PR2a.PolicyPerformanceMetric −= 20 * | // PolicyEvalAction |
| 413 intf0.intrusion_succeeded_count; | // (fast penalty) |
| 414 intf0.intrusion_succeeded_count = 0; | // PolicyEvalAction |
| 415 PR2a.PolicyPerformanceMetric = | // PolicyEvalAction |
| 416 (PR2a.PolicyPerformanceMetric < −100.0) ? | |
| 417 −100.0 : PR2a.PolicyPerformanceMetric; | |
| 418 ELSE | |
| 419 PR2a.PolicyPerformanceMetric += 0.1; | // PolicyEvalAction |
| 420 | // (slow reward) |
| 421 PR2a.PolicyPerformanceMetric = | // PolicyEvalAction |
| 422 (PR2a.PolicyPerformanceMetric > 100.0) ? | |
| 423 100.0 : PR2a.PolicyPerformanceMetric; | |
| 424 ENDIF | |
| 425 END_EVENT | |
| 426 END_RULE | |

Pseudocode Section #4 extends the example policy rule PR2a. In particular, the policy evaluation event 105 (shown on line 410) does not depend on any action of the original policy rule PR2a. Instead, on line 410, the policy evaluation triggers on a 10 second event generated, for example, by the underlying operating system. The policy evaluation condition 106 on line 411 tests for a successful intrusion (i.e., the value of the policy evaluation condition was TRUE), which indicates that policy rule PR2a has failed the basic goal of keeping the network safe from intrusions. Lines 412 and 413 define a policy evaluation action 107 that quickly decrements the policy performance metric for PR2a in response to this failure. The policy evaluation action 107 on line 414 resets the successful intrusion counter. The policy evaluation action 107 on lines 415 through 417 creates a minimum performance metric of −100.0 for this example. Lines 419 through 423 define an otherwise policy evaluation action 107 to be executed when the policy evaluation condition 106 on line 411 evaluates to FALSE. The otherwise policy evaluation action 107 on line 419 gradually rewards PR2a by incrementing its performance metric when no intrusions have succeeded. The otherwise policy evaluation action 107 on lines 421 through 423 caps the example performance metric at 100.0.

The failure of PR2a could stem from a failure to act. As such, the present invention's ability to conduct evaluation of a policy rule 101 without requiring policy rule 101 to act (e.g without PR2a activating a policy action 104) conveys significant value.

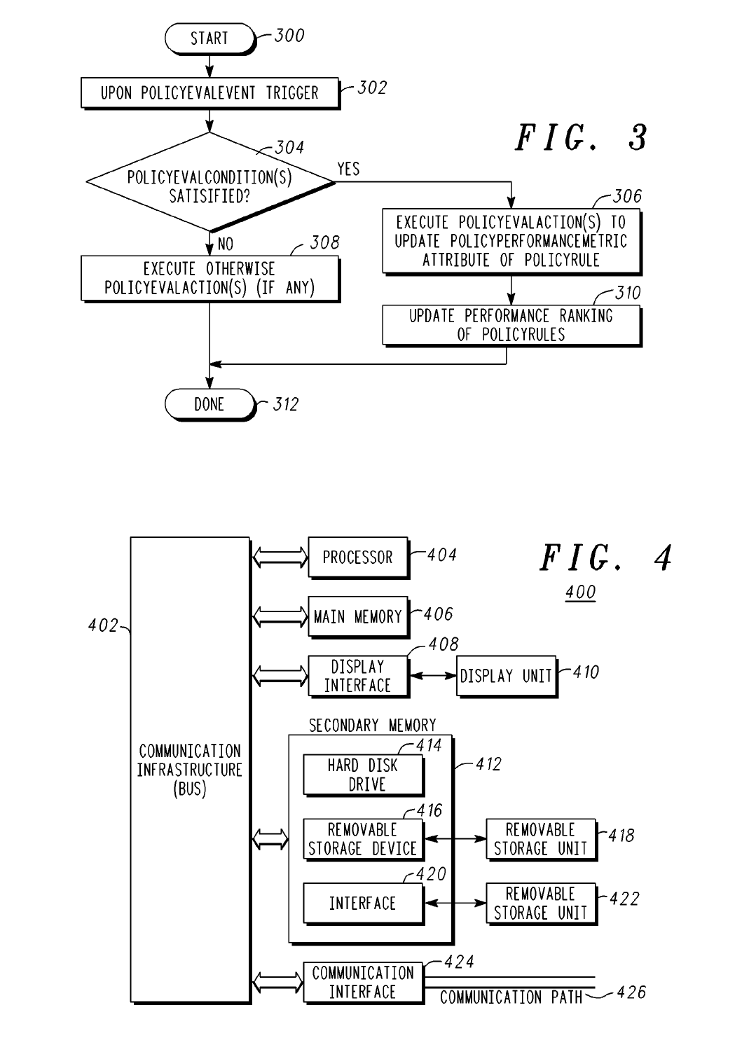

FIG. 3 shows a process flow diagram of an evaluation of policy performance according to an embodiment of the present invention and consistent with the policy rule 101 structure shown in FIG. 1. The procedure starts at step 300 and moves directly to step 302. Upon the policy evaluation event(s) 105 being triggering in step 302, the flow moves to step 304 where the policy evaluation condition(s) 106 are evaluated. If the policy evaluation condition(s) are satisfied (also termed passing or evaluating to TRUE), then the policy evaluation action(s) are executed at step 306 to update the policy performance metric of the policy rule 101. It should be noted that many policy evaluation actions 107 may be executed in support of policy performance evaluation as well as other possible ends. In some embodiments of the present invention, the performance ranking of policy rules 101 may be updated at step 310, and then ends at step 312. The update to the performance metric may, for example, be accomplished by means of an explicit policy evaluation action 107 or implicitly and automatically upon update of the policy performance metric.

If, in step 304, the policy evaluation condition(s) are not satisfied (also termed “failing” or evaluating to FALSE), then the otherwise policy evaluation action(s) are executed at step 308 and then the process flow ends at step 312. It should be noted that, in this example, no update is conducted as a result of performing step 308 on the otherwise policy evaluation action(s) 107 path. This need not always be the case, as shown above in the example Pseudocode Section #4, where both the policy evaluation action 107 and otherwise policy evaluation action 107 paths update the policy rule's 101 policy performance metric.

The following table, TABLE 1, is a policy rule list with performance rating/ranking showing one example of how policy rules 101 might be rated and ranked within the policy server 202. It should be noted here that the policy performance metric can be many things. The real values shown in the Table 1 are for illustrative purposes only to show concept, but the actual values can be integers, words, priority levels, or anything that allows ones to discern the performance of individual policy evaluation performance into any sort of ranked list or list:

TABLE 1

| Policy Rule Name | Policy Performance Metric |
|---|---|
| PR1a | 80.0 |
| PR2a | 53.2 |
| PR3a | −100.0 |

TABLE 1 is just one example of how policy rules 101 might be rated and ranked by the performance rating 212 function, according to descending policy performance metrics within the policy server 202. Table 1 is small for purposes of clarity and simplicity. In practice, such at table could be much larger with many instances of the same named policy serving differing managed entities 206 and 208 with possibly differing policy performance metrics. In some embodiments of the present invention, the performance rating 212 function might aggregate (for example, by averaging) all policy performance ratings into a rating for the entire class of policy rules 101. These policy performance metrics might be further aggregated between policy servers 202 by the policy broker 214. Other mathematical organization, comparison, and manipulations are contemplated and are within the spirit and scope of the invention.

Code Section #5 is an example of policy conflict and illustrating how certain embodiments of the present invention can be used to assist in policy conflict resolution.

Code Section #5:

| | |
|---|---|
| 501 POLICY_RULE PR1a | // Defining PR1a |
| 502 ON_EVENT intf0.threshold_alarm | // PolicyEvent |

503 IF intf0.ifPktsDropped > SLA1.max_threshold1 // PolicyCondition
THEN

| | |
|---|---|
| 504 ChangeQueuingPolicy(intf0, | // PolicyAction |
| violateQueuingPolicy); | |
| 505 Set(intf0.ifPktsForwarded, 0); | // PolicyAction |
| 506 ThrowEventDelayed(PR1a_Evaluate, 10.0); | // PolicyAction |
| 507 ENDIF | |
| 508 END_EVENT | |
| 509 | |
| 510 ON_EVENT PR1a_Evaluate | // PolicyEvalEvent |
| 511 IF intf0.ifPktsForwarded > 1000000 THEN | // PolicyEvalCondition |
| 512 PR1a.PolicyPerformanceMetric = 200.0 * | // PolicyEvalAction |
| 513 ((SLA1.max_threhold1 − | |
| intf0.ifPktsDropped) / | |
| 514 SLA1.max_threshold1) + 100.0; | |
| 515 ELSE | |
| 516 ThrowEventDelayed(PR1a_Evaluate, 10.0); | // PolicyEvalAction |
| 517 ENDIF | |
| 518 END_EVENT | |
| 519 END_RULE | |
| 520 | |
| 521 POLICY_RULE PR3a | // Defining PR3a |
| 522 ON_EVENT System_10sec_tic | // PolicyEvent |

523 IF intf0.ifUntilization < SLA1.target_utilization // PolicyCondition
THEN
524 ChangeQueuingPolicy(intf0, liberalQueuingPolicy);// PolicyAction

| | |
|---|---|
| 525 ENDIF | |
| 526 END_EVENT | |
| 527 | |
| 528 ON_EVENT System_100sec_tic | // PolicyEvalEvent |
| 529 IF intf0.ifUtilization < | // PolicyEvalCondition |
| SLA1.target_utilization THEN | |
| 530 PR3a.PolicyPerformanceMetric = −100.0; | // PolicyEvalAction |
| 531 ELSE | |
| 532 PR3a.PolicyPerformanceMetric = | // PolicyEvalAction |
| 533 inf0.ifUtilization * 100.0; | |
| 534 ENDIF | |
| 535 END_EVENT | |
| 536 END_RULE | |

Code Section #5 defines two policy rules 101 enhanced according to the present invention with policy performance metric evaluation. PR1a was introduced in Code Sections #1 and #2 and is repeated here for convenience. Policy rule PR1a works to maintain an acceptably low level of packet dropping on interface 0. PR3a is introduced in this code section and is defined in policy pseudocode on lines 921 through 936. The goal of PR3a is to maintain an acceptably high average usage of interface 0 by using a liberal queuing policy to attract more network traffic when the interface is not being sufficiently utilized. PR1a and PR3a can conflict when average utilization of interface 0 for a given time period is low, but a burst of traffic at the end of the average utilization period causes a high proportion of dropped traffic. In this case, for PR3a's 10 second interval event, when (intf0.ifUtilization<SLA1.target_utilization) and for PR1a, when an intf0.threshold_alarm event occurs and (intf0.ifPktsDropped>SLA1.max_threshold1), the policy rules conflict because of two differing commands that simultaneously execute (i.e., set the queuing policy to a liberal queuing policy and set the queuing policy to a violate queuing policy). In certain embodiments of the present invention, this policy conflict can be resolved by examining the policy performance metrics of the conflicting policies and favoring the policy rule 101 with a higher policy performance metric. Using the example policy performance shown above in Table 1, the policy conflict of example Code section #5 would be resolved in favor of PR1a since it has the higher policy performance metric.

FIG. 4 is a high level block diagram illustrating a detailed view of a computing system 400 useful for implementing the policy server 202 according to embodiments of the present invention. The computing system 400 is based upon a suitably configured processing system adapted to implement an exemplary embodiment of the present invention. For example, a personal computer, workstation, or the like, may be used.

In one embodiment of the present invention, the computing system 400 includes one or more processors, such as processor 404. The processor 404 is connected to a communication infrastructure 402 (e.g., a communications bus, crossover bar, or network). Various software embodiments are described in terms of this exemplary computer system. After reading this description, it will become apparent to a person of ordinary skill in the relevant art(s) how to implement the invention using other computer systems and/or computer architectures.

The computing system 400 can include a display interface 408 that forwards graphics, text, and other data from the communication infrastructure 402 (or from a frame buffer) for display on the display unit 410. The computing system 400 also includes a main memory 406, preferably random access memory (RAM), and may also include a secondary memory 412 as well as various caches and auxiliary memory as are normally found in computer systems. The secondary memory 412 may include, for example, a hard disk drive 414 and/or a removable storage drive 416, representing a floppy disk drive, a magnetic tape drive, an optical disk drive, etc. The removable storage drive 416 reads from and/or writes to a removable storage unit 418 in a manner well known to those having ordinary skill in the art. Removable storage unit 418, represents a floppy disk, a compact disc, magnetic tape, optical disk, etc. which is read by and written to by removable storage drive 416. As will be appreciated, the removable storage unit 418 includes a computer readable medium having stored therein computer software and/or data. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer-readable information.

In alternative embodiments, the secondary memory 412 may include other similar means for allowing computer programs or other instructions to be loaded into the policy server 202. Such means may include, for example, a removable storage unit 422 and an interface 420. Examples of such may include a program cartridge and cartridge interface (such as that found in video game devices), a removable memory chip (such as an EPROM, or PROM) and associated socket, and other removable storage units 422 and interfaces 420 which allow software and data to be transferred from the removable storage unit 422 to the computing system 400.

The computing system 400, in this example, includes a communications interface 424 that acts as an input and output and allows software and data to be transferred between the policy server 202 and external devices or access points via a communications path 426. Examples of communications interface 424 may include a modem, a network interface (such as an Ethernet card), a communications port, a PCMCIA slot and card, etc. Software and data transferred via communications interface 424 are in the form of signals which may be, for example, electronic, electromagnetic, optical, or other signals capable of being received by communications interface 424. The signals are provided to communications interface 424 via a communications path (i.e., channel) 426. The channel 426 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 406 and secondary memory 412, removable storage drive 416, a hard disk installed in hard disk drive 414, and signals. The computer program products are means for providing software to the computer system. The computer readable medium allows the computer system to read data, instructions, messages or message packets, and other computer readable information from the computer readable medium.

Computer programs (also called computer control logic) are stored in main memory 406 and/or secondary memory 412. Computer programs may also be received via communications interface 424. Such computer programs, when executed, enable the computer system to perform the features of the present invention as discussed herein. In particular, the computer programs, when executed, enable the processor 404 to perform the features of the computer system.

The present invention, according to certain embodiments, provides a system and method for assessment of policy performance versus the goals of a policy-based network in which they operate. Embodiments of the invention are advantageous in that they allow poor performing policies to be identified and addressed, such as by reducing a policy's priority (e.g. they are less likely to win a policy conflict resolution) or by calling attention to the policy for editing and refinement by policy authors.

### NON-LIMITING EXAMPLES

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method for evaluating performance of a policy rule, the method comprising:
accessing at least one policy rule having associated with it at least one policy event, at least one policy condition, and at least one policy action;
associating with the policy rule at least one policy evaluation event, at least one policy evaluation condition, and at least one policy evaluation action, wherein the policy evaluation event is either partially or fully independent of the policy event that triggers evaluation of the policy conditions in the policy rule; and
assessing a performance of the policy rule by utilizing the policy evaluation event, the policy evaluation condition, and the policy evaluation action.

2. The method according to claim 1, wherein the policy evaluation action can execute independently of the policy action associated with the policy rule.

3. The method according to claim 1, wherein the associating includes a policy evaluation condition that is independent of the policy condition.

4. The method according to claim 1, further comprising:
performing the policy evaluation action associated with the policy rule and at least one additional policy evaluation action on at least one additional policy rule; and
ranking the policy rule against the additional policy rule based on the result of the policy evaluation action and the at least one additional policy evaluation action.

5. The method according to claim 4, further comprising:
utilizing the ranking to resolve a conflict between two policy rules.

6. The method according to claim 1, further comprising:
performing the policy evaluation action on the policy rule; and
manipulating a numerical score associated with the policy rule based on a result of the policy evaluation action.

7. The method according to claim 1, further comprising:
performing the policy evaluation action on the policy rule; and
comparing a result of the policy evaluation action to a threshold value.

8. The method according to claim 7, further comprising:
notifying an operator of the result of the policy evaluation action if the result of the policy evaluation action is outside a range of the threshold.

9. The method according to claim 1, further comprising:
coordinating an application of two differing policy rules with a policy broker.

10. The method according to claim 1, wherein the policy evaluation action is independent of the policy rule.

11. A system for evaluating performance of a policy rule, the system comprising:
a memory adapted to store at least one policy rule, at least one policy event, at least one policy condition, and at least one policy action;
a processor communicatively coupled to the memory and adapted to:
access the at least one policy rule;
associate at least one of the policy events, at least one of the policy conditions, and at least one of the policy actions with the policy rule;
associate at least one policy evaluation event, at least one policy evaluation condition, and at least one policy evaluation action with the policy rule, wherein the at least one policy evaluation event is independent of the at least one policy event, which triggers the policy rule; and
assess a performance of the policy rule by utilizing the policy evaluation event, the policy evaluation condition, and the policy evaluation action.

12. The system according to claim 11, wherein the policy evaluation action can execute independently of the policy action associated with the policy rule.

13. The system according to claim 11, wherein the associating includes a policy evaluation condition that is independent of the policy condition.

14. The system according to claim 11, wherein the processor is further adapted to:
perform the policy evaluation action associated with the policy rule and at least one additional policy evaluation action on at least one additional policy rule; and
rank the policy rule against the additional policy rule based on a result of the policy evaluation action.

15. The system according to claim 14, wherein the processor is further adapted to utilize the rank to resolve a conflict between two policy rules.

16. The system according to claim 11, wherein the processor is further adapted to:
perform the policy evaluation action on the policy rule; and
manipulate a numerical score associated with the policy rule based on a result of the policy evaluation action.

17. The system according to claim 11, wherein the processor is further adapted to:
perform the policy evaluation action on the policy rule; and
compare a result of the policy evaluation action to a threshold value.

18. The system according to claim 17, wherein the processor is further adapted to:
notify an operator of the result of the policy evaluation action if the result of the policy evaluation action is outside a range of the threshold.

19. The system according to claim 11, wherein the processor is further adapted to:
coordinate an application of two differing policy rules with a policy broker.

20. The system according to claim 11, wherein the policy evaluation action is independent of the policy rule.
